(19) United States
(12) Patent Application Publication
(10) Pub. No.: US 2005/0157826 A1
(43) Pub. Date: Jul. 21, 2005

(54) Filtering signals

(75) Inventor: Paavo Vaananen, Nokia (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/988,188

(22) Filed: Nov. 12, 2004

(30) Foreign Application Priority Data
Nov. 14, 2003 (FI) 20035209

(51) Int. Cl. H04B 1/38

(52) U.S. Cl. 375/350

(57) ABSTRACT

The invention relates to an IF polyphase filter for filtering received RF signals. The signals are downconverted into intermediate frequency signals before filtering them in the IF polyphase filter. The IF polyphase filter comprises means for defining a passband for the IF polyphase filter. The IF polyphase filter further comprises a passband adapting element for setting the passband of the IF polyphase filter in positive or in negative frequencies. The invention further relates to a receiver comprising the IF polyphase filter according to the invention. The invention further relates to a method for filtering received RF signals by using an IF polyphase filter. The method comprises downconverting the received RF signals into intermediate frequency signals before filtering them in the IF polyphase filter, and defining a passband for the IF polyphase filter. The passband of the IF polyphase filter is set in positive or in negative frequencies.

### CROSS-REFERENCE TO RELATED APPLICATIONS

This application claims priority under 35 USC §119 to Finnish Patent Application No. 20035209 filed on Nov. 14, 2003.

### FIELD OF THE INVENTION

The present invention relates to an intermediate frequency (IF) polyphase filter for filtering received radio frequency (RF) signals downconverted into intermediate frequency signals, comprising means for defining a passband for the IF polyphase filter. The invention also relates to a receiver comprising at least an input for receiving RF signals, downconverting means for downconverting the received RF signals into intermediate frequency signals, and an IF polyphase filter for filtering the intermediate signals to separate wanted signals from disturbing signals. The invention also relates to a device comprising a receiver, which comprises at least an input for receiving RF signals, downconverting means for downconverting the received RF signals into intermediate frequency signals, and an IF polyphase filter for filtering the intermediate signals to separate wanted signals from disturbing signals. The invention further relates to a method for filtering received RF signals by using an IF polyphase filter, the method comprising downconverting the received RF signals into intermediate frequency signals before filtering them in the IF polyphase filter, and defining a passband for the IF polyphase filter. The invention also relates to a system comprising a receiver, which comprises at least an input for receiving RF signals, downconverting means for downconverting the received RF signals into intermediate frequency signals, and an IF polyphase filter for filtering the intermediate signals to separate wanted signals from disturbing signals.

### BACKGROUND OF THE INVENTION

In some present receivers the bandwidth of the front-end analog IF filter is not calibrated due to minimization of the chip area and the cost.

This means that typically the IF bandwidth of the receiver is larger than the bandwidth of the actual signal which the receiver is intended to receive (i.e. the wanted signal). When such a receiver is placed in a device comprising a transmitter transmitting signals on a frequency band near the receiving frequency band of the receiver, a disturbing signal (a jamming signal) may exist in the input of the receiver that is outside the actual signal band but still in the received analog band. This is due to the fact that the disturbing signal is not attenuated enough and when the received signals are downconverted by a local oscillator to the IF frequency band also the disturbing signal is downconverted to the IF frequency band. After the downconversion it is almost impossible to separate the disturbing signal from the actual signal.

At present there are some mobile communication devices which also comprise a satellite positioning system receiver, for example a Global Positioning System (GPS) receiver or a Global Orbiting Navigation Satellite System (GLONASS) receiver. The signal frequencies of the satellite positioning systems are not very far apart from the signal frequencies of, for example, mobile communication systems such as GSM. As a result the transmitter of the mobile communication device may cause disturbing signals to the satellite positioning system receiver. Another cause of jamming can be due to signals generated in the mobile communication receiver. For example, local oscillator signals are generated in the receiver for transforming signals received from a mobile communication network into IF signals. The frequency of the local oscillator signals or some harmonic components of the local oscillator signals or reference crystal oscillator signals may couple to the RF input of the satellite positioning system receiver and can generate spurious signals or other disturbances in the satellite positioning system receiver.

The above described problem is hard to solve especially in low IF receivers, i.e. receivers in which the IF band is near the baseband. This is due to the fact that the frequency of the local oscillator signal has to be near the frequency of the signals to be received from the satellite positioning system because the difference between the frequency of the signals to be received and the frequency of the local oscillator determine the IF band. Therefore, other strong enough signals laying at a suitable distance from the local oscillator signal can disturb the low IF receiver. Typically the IF band lies around from a few hundred kilohertz up to couple of megahertz and its bandwidth is about 1 to 4 times the bandwidth of the baseband.

FIG. 1a depicts a situation in which a receiver is receiving signals on a certain frequency band i.e. how the receiver “sees” the signals at the front end. These wanted signals are marked with the reference 56 in FIG. 1a. The frequency of the local oscillator (LO) is slightly below the frequency band of the wanted signals and it is marked with the reference numeral 2. In this example the disturbing signal 55 lies slightly above the frequency band of the wanted signals. When the received signals are downconverted they are shifted to the IF frequency band. This situation is depicted in FIG. 1b. In FIG. 1b, also the pass band of the IF filter is shown and marked with the reference numeral 60. As can be seen in FIG. 1b the disturbing signal is downconverted inside the pass band of the IF filter. This means that the disturbing signal is also amplified and forwarded to a demodulation stage of the receiver. Thus, the disturbing signal can even hinder the demodulation of the wanted signal or cause distortion to the demodulation result of the wanted signal.

There are several known ways of implementing a low IF receiver. Firstly, fully real analog signal processing may be used i.e. the signal is treated as a real signal in analog form. This means that a real mixer and real analog bandpass or low-pass filtering are used. The real mixer and real analog bandpass or low-pass filtering operate only with real signals, not with complex signals comprising a real part and an imaginary part. In digital signal processing it is also possible to design the mixers and filters so that they can divide the signal into quadrature components and operate with complex signals. In practice a real bandpass filter is hard or even impossible to realize as an on-chip device for a low IF receiver. Using a real mixer and a real low-pass filter is one solution that yields to a high level of integration but has no image rejection in IF before analog to digital conversion and so leads to stricter requirements for filtering signals in radio frequency band (RF), for example, in the front end stages of the receiver.

Regarding a receiver, an image frequency is an undesired input frequency that is capable of producing the same intermediate frequency that the desired input frequency produces. The image rejection means that the image frequencies are rejected (or at least significantly attenuated if the full rejection is not possible to achieve).

Secondly, there is an option to use complex i.e. polyphase analog signal processing. Using a complex mixer and an analog polyphase filter a bandpass function with image rejection can be created. Furthermore, that kind of filter architecture can easily be integrated to an application specific integrated circuit (ASIC) so saving the cost by relaxing the requirements for filtering signals in radio frequency band (RF) and decreasing the number of components outside the ASIC.

However, one downside of using an on-chip integrated complex mixer and analog polyphase filter compared to an external IF bandpass filter is that, due to process variations, the bandwidth of the filter changes more and so needs to be more oversized, i.e. the bandwidth of the average filter unit needs to be wider than the actual received signal bandwidth and the sharpness of the bandpass of the filter has to be increased in order to provide enough attenuation to signals outside of the bandpass, or calibrated, i.e. the filter has to be tuned to locate the bandpass properly. A disadvantage of the calibration is that structures needed are typically area consuming and in some cases hard to insert into the actual functional design so that the performance is not adversely affected. Also in some signal bands the requirements for the receiver filtering are not so strict meaning that adjacent channel attenuation is not the main parameter that sets the specification.

For instance, this is the case with GPS signal and calibration of the bandpass function is not necessarily needed but the IF filter band can be oversized so that it meets the specifications regardless of the process variations in the ASIC production. Nevertheless, if the receiver works in a multistandard mobile communication device it needs to be tolerant against possible narrowband interferers.

A polyphase signal is a vector of independent signals. In this application only a special case of the polyphase signals are considered, namely, two-phase signals. In two-phase system the vectors are two-dimensional and can be represented as follows:
u(t)=uᵣ(t)+juᵢ(t)
U(jω)=Uᵣ(jω)+jUᵢ(jω) (1)

In Equation (1) u(t) is a two-phase signal in time-domain, uᵣ(t) is the real component of u(t), and uᵢ(t) is the imaginary component of u(t). U(jω) is the signal in the frequency-domain, Uᵣ(jω) is the real component of U(jω), and Uᵢ(jω) is the imaginary component of U(jω).

These two-phase signals are also called complex signals. Every frequency component of u(t) can be written as a sum of two sequences. The two sequences of a real signal uᵣ(t) always have the same amplitude and the opposite phase.

$$\begin{matrix}A ( ω ) cos [ ω t + φ ( ω ) ] = \frac{A ( ω )}{2} \{ cos [ ω t + φ ( ω ) ] + j sin [ ω t + φ ( ω ) ] \} + \\ \frac{A ( ω )}{2} \{ cos [ ω t + φ ( ω ) ] - j sin [ ω t + φ ( ω ) ] \}\end{matrix} \qquad ( 2 )$$

The first sequence has only a positive frequency component, the second one only a negative frequency component.
A(ω){ cos [ωt+φ(ω)]+j sin [ωt+φ(ω)]}=A(ω)e^{jφ(ω)}e^{jωt}
A(ω){ cos [ωt+φ(ω)]−j sin [ωt+φ(ω)]}=A(ω)e^{-jφ(ω)}e^{-jωt} (3)

The combination of the equations (2) and (3) results in

$$A ( ω ) cos [ ω t + φ ( ω ) ] = \frac{A ( ω )}{2} {ⅇ}^{j φ ( ω )} {ⅇ}^{j ω t} + \frac{A ( ω )}{2} {ⅇ}^{- j φ ( ω )} {ⅇ}^{- j ω t} \qquad ( 4 )$$

It can be seen from the above that any complex signal A(ω) can be represented as a sum of positive (above 0 Hz) and negative frequency components (below 0 Hz).

### SUMMARY OF THE INVENTION

The present invention provides a possibility to configure the passband of a polyphase filter. In detail, it means that the passband of the IF filter can be set to positive or to negative frequencies.

The invention also provides a complex IF filter based on current summing topology that enables receiving either positive or negative frequency providing image rejection for the unwanted band. In other words, by using the circuits of the present invention it is possible to select the local oscillator of the complex IF receiver working at either a higher or lower frequency than the wanted band.

According to one aspect of the present invention, there is provided an IF polyphase filter for filtering received RF signals downconverted into intermediate frequency signals, comprising means for defining a passband for the IF polyphase filter. The filter is primarily characterized in that the IF polyphase filter further comprises setting means for setting the passband of the IF polyphase filter in positive or in negative frequencies.

According to another aspect of the present invention, there is provided a receiver comprising at least an input for receiving RF signals, downconverting means for downconverting the received RF signals into intermediate frequency signals, and an IF polyphase filter for filtering the intermediate signals to separate wanted signals from disturbing signals. The receiver is primarily characterized in that the receiver further comprises setting means for setting the passband of the IF polyphase filter in positive or in negative frequencies.

According to a third aspect of the present invention, there is provided a device comprising a receiver, which comprises at least an input for receiving RF signals, downconverting means for downconverting the received RF signals into intermediate frequency signals, and an IF polyphase filter for filtering the intermediate signals to separate wanted signals from disturbing signals. The device is primarily characterized in that the device further comprises setting means for setting the passband of the IF polyphase filter in positive or in negative frequencies

According to a fourth aspect of the present invention, there is provided a method for filtering received RF signals by using an IF polyphase filter, the method comprising downconverting the received RF signals into intermediate frequency signals before filtering them in the IF polyphase filter, and defining a passband for the IF polyphase filter. The method is primarily characterized in that the passband of the IF polyphase filter is set in positive or in negative frequencies.

According to a fifth aspect of the present invention, there is provided a system comprising a receiver, which comprises at least an input for receiving RF signals, downconverting means for downconverting the received RF signals into intermediate frequency signals, and an IF polyphase filter for filtering the intermediate signals to separate wanted signals from disturbing signals. The system is primarily characterized in that the system further comprises setting means for setting the passband of the IF polyphase filter in positive or in negative frequencies.

The filter according to a embodiment of the present invention comprises a first and a fourth transconductance amplifier for amplifying the intermediate frequency signals, and a second and a third transconductance amplifier for setting the passband of the IF polyphase filter in positive or in negative frequencies.

In the filter according to another embodiment of the present invention said setting means comprise means for setting the transconductance of said second and third transconductance amplifier to positive or negative.

In the filter according to still another embodiment of the present invention said setting means comprise an analog multiplier.

The present invention has significant advantages compared with prior art solutions. By careful frequency planning the inband interferers can be avoided and the receiver architecture with a controllable intermediate frequency polyphase filter gives some more freedom for the frequency planning of the system by providing a way to get the receiver more tolerant against narrowband interference in e.g. a multistandard environment. A further advantage is that this option can be realized with much simpler control logic and less area than the calibration of the filter would require.

When compared the filter of the present invention with an external IF filter of the prior art it can be seen that less printed wired board (PWB) area is needed. Also when compared with tuning of the filter the invention achieves savings in on-chip area and, hence, savings in costs.

### BRIEF DESCRIPTION OF THE DRAWINGS

FIG. 1a shows an example of a frequency spectrum of a wanted signal, a disturbing signal and a local oscillator signal at a front-end of a receiver,

FIG. 1b shows the frequency spectrum of FIG. 1a downconverted to a low IF in the receiver,

FIG. 1c shows another example of a frequency spectrum of a wanted signal, a disturbing signal and a local oscillator signal at a front-end of a receiver,

FIG. 1d shows the frequency spectrum of FIG. 1c downconverted to a low IF in the receiver according to the present invention,

FIG. 2 is a block diagram of a low IF receiver with configurable polyphase IF filter according to the present invention,

FIG. 3 shows how the configurable polyphase IF filter may be implemented by using transconductance amplifiers,

FIGS. 4a and 4b describe an implementation of transconductance stages according to the present invention using differential pairs,

FIG. 5 shows an example of an electronic device according to the present invention, and

FIG. 6 shows as a flow diagram an example of a method according to the present invention.

### DETAILED DESCRIPTION OF THE INVENTION

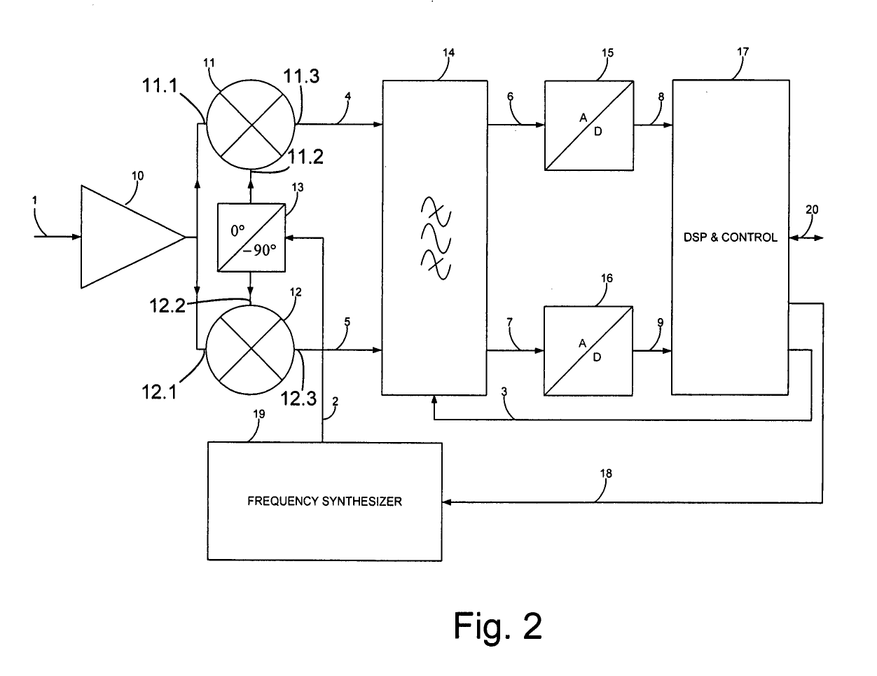

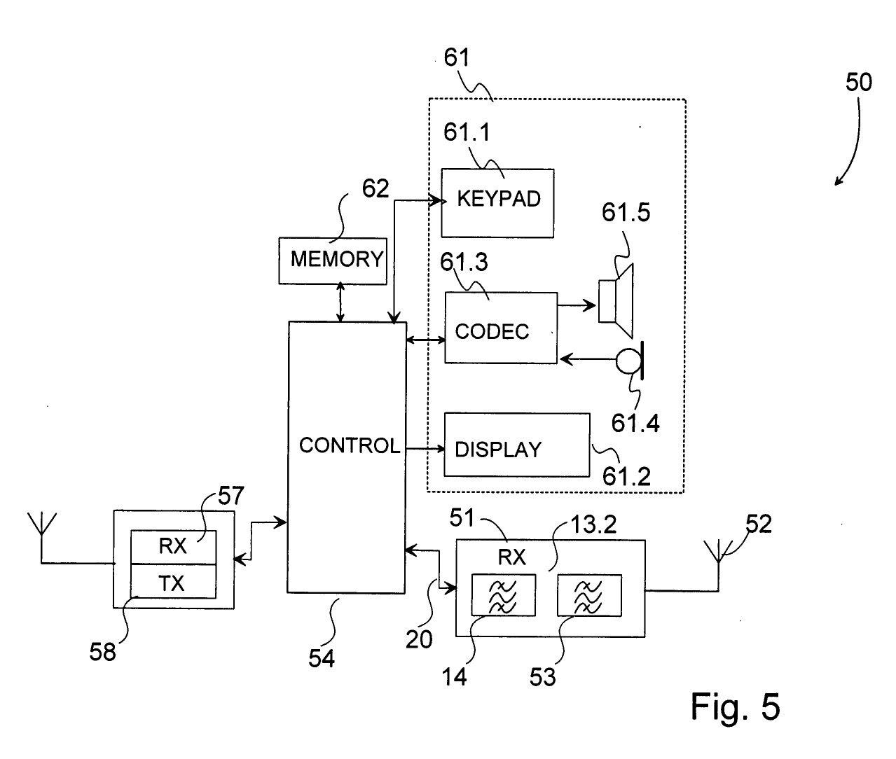

In the following, the present invention will be described in more detail husing the electronic device 50 of FIG. 5 as an example. The electronic device 50 comprises a receiver 51 in which a filter 14 according to an embodiment of the present invention is utilized. The details of the receiver 51 and the filter 14 are depicted in FIGS. 2, 3, 4a and 4b.

Radio frequency signals are received by an antenna 52 and led to the input 1 (the front-end) of the receiver 51 through a bandpass filter 53 (FIG. 5). The bandpass filter 53 is used to filter out signals which are outside the frequency band of the wanted signals. However, the bandwidth of the filter is broader than the bandwidth of the actual signals as was already mentioned above in the description. Referring now to FIG. 2, the received signals passed through the antenna coupler 53 are amplified by the low noise high frequency amplifier 10. After that, the amplified signals are directed to a first input 11.1 of a first mixer 11 and to a first input 12.1 of a second mixer 12 for mixing the signals with a local oscillator signal 2. The local oscillator signal 2 is generated by a frequency synthesizer 19 or by another oscillator. In the phase shifter 13 an in-phase local oscillator signal and a quadrature-phase local oscillator signal are generated from the local oscillator signal 2. The in-phase local oscillator signal is connected to a second input 11.2 of the first mixer 11. The quadrature-phase signal is connected to a second input 12.2 of the second mixer 12. The first mixer 11 performs downconversion of the in-phase signal by mixing the received signal with the in-phase local oscillator signal. At the output 11.3 of the first mixer 11 is a downconverted, low IF signal 4 i.e. the I-component of the downconverted signal. The second mixer 12 performs a similar downconversion operation on the quadrature-phase signal by mixing the received signal with the quadrature-phase local oscillator signal. At the output 12.3 of the second mixer 12 is a quadrature downconverted, low IF signal 5 i.e. the Q-component of the downconverted signal. The downconverted, low IF signal components 4, 5 are fed to an IF filter 14 for filtering the low IF signal components. After the filtering the filtered I-signal component 6 is sampled by a first analog-to-digital converter 15 to form digitized samples of the filtered I-signal component. The filtered Q-signal component 7 is sampled by a second analog-to-digital converter 16 to form digitized samples of the filtered Q-signal component in a similar manner. The I- and Q-samples are then further processed in block 17. The block 17 represents digital parts of the receiver that are connected to controller and application processor 54 (FIG. 5) through bus 20. The block 17 comprises, for example, a digital signal processor (DSP) and/or a controller known as such.

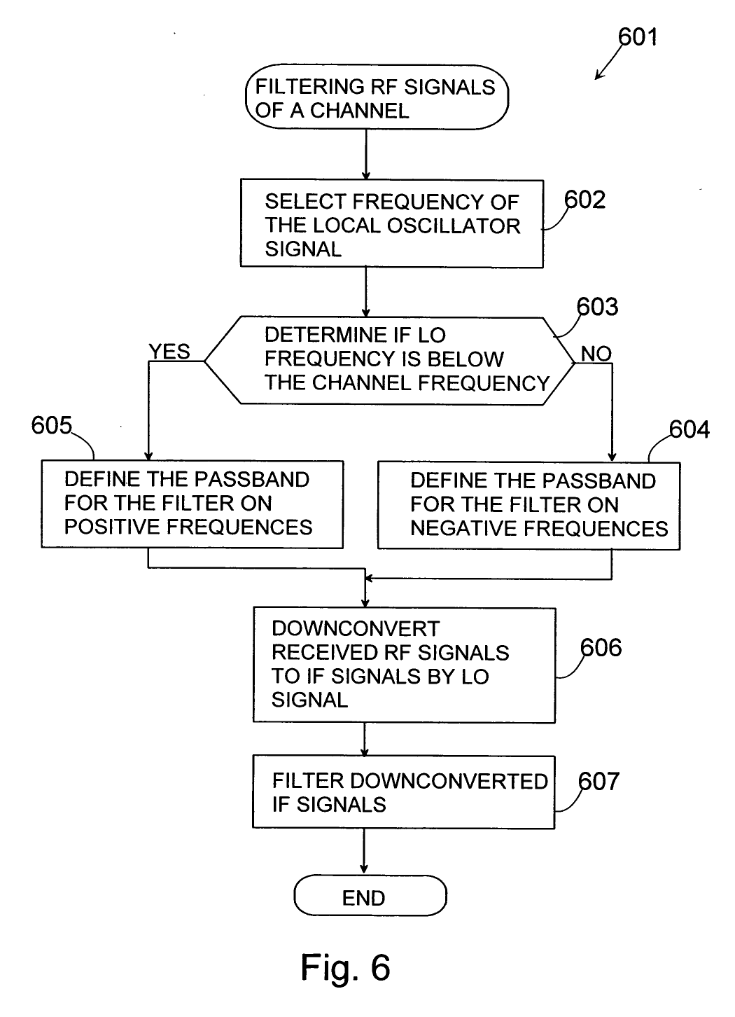

A filter control signal 3 and the frequency of the local oscillator signal 2 must be set in a right manner compared to the wanted channel (frequency band of the signal that is to be received) in order to set the passband of the filter 14 to the wanted channel. The flow diagram 601 of FIG. 6 discloses some of the steps to control the filter 14. In the receiver 51 according to the present invention the frequency of the local oscillator signal 2 is set 602 to be either below the wanted channel i.e. RF−IF, or above the wanted channel i.e. RF+IF. The control signal 3 is set to a value with which the passband of the filter 14 is either on negative frequencies, if the frequency of the local oscillator signal is above the wanted channel, or positive frequencies, if the frequency of the local oscillator signal is below the wanted channel. The block 17 determines 603 the correct settings for the passband of the filter 14 and the frequency of the local oscillator signal 2 and uses the filter control signal 3 and the local oscillator control signal 18 for controlling 604, 605 the filter 14 and the frequency synthesizer 19. The signals are then downconverted 606 and filtered 607.

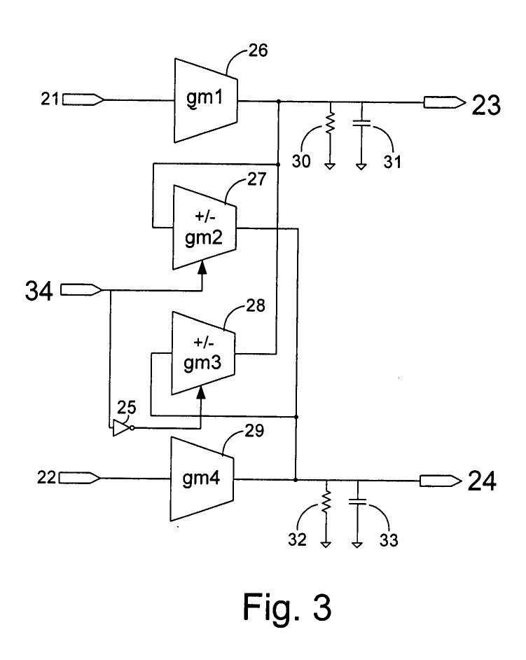

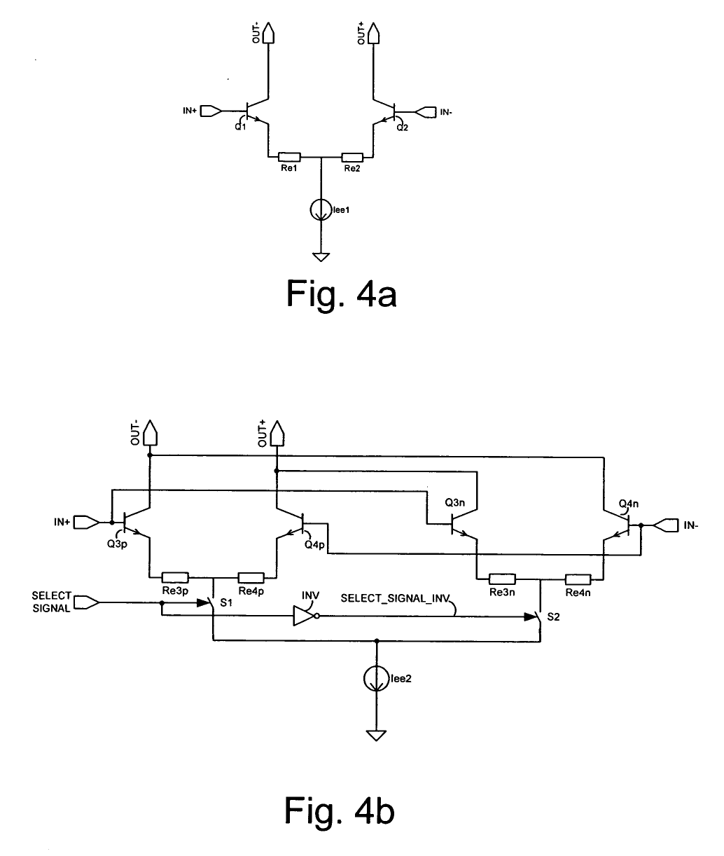

Next, the details of an example of the IF filter 14 according to the present invention will be described with reference to FIGS. 3, 4a and 4b.

According to an embodiment of the invention illustrated in FIG. 3 the IF filter 14 is implemented using a transconductance amplifier. For clarity, the figure is presented for single-ended signals but the filter can be realized in differential mode as well. The IF filter 14 has four transconductance amplifier stages 26-29, an in-phase input 21 and a quadrature-phase input 22, an in-phase output 23 and a quadrature-phase output 24. The in-phase input 21 is connected to the input of the first transconductance amplifier 26 and the quadrature-phase input 22 is connected to the input of the fourth transconductance amplifier 29. The output of the first transconductance amplifier 26 is connected to the in-phase output 23 of the IF filter 14 and also to the input of the second transconductance amplifier 27. Further, the output of the fourth transconductance amplifier 29 is connected to the quadrature-phase output 24 of the IF filter 14 and also to the input of the third transconductance amplifier 28. There is also a control input 34 in the filter which is connected to a control input of the second transconductance amplifier 27. The control input signal is also inverted in an inverter 25 to change the sign of the transconductance gm3 of the third transconductance amplifier 28 opposite to the sign of the transconductance gm2 of the second transconductance amplifier 27. The output of the inverter 25 is therefore connected to the control input of the third transconductance amplifier 28. The absolute value of the transconductance gm3 of the third transconductance amplifier 28 should be substantially equal to the transconductance gm2 of the second transconductance amplifier 27. Further, the transconductance gm1 of the first transconductance amplifier 26 should be substantially equal to the transconductance gm4 of the fourth transconductance amplifier 29.

The first transconductance amplifier 26 and the fourth transconductance amplifier 29 together with resistors 30 and 32 define the gain of the filter stage. The second transconductance amplifier 27 and the third transconductance amplifier 28 together with resistors 30 and 32 and capacitors 31 and 33 define the center frequency and bandwidth of the filter stage. The control signal from the control input block 34 defines the sign of the transconductance gm2 of the second transconductance amplifier 27 and the transconductance gm3 of the third transconductance amplifier 28. The sign of the transconductance gm2 of the second 27 and the sign of the transconductance gm3 of the third transconcuctance amplifier 28 determine whether the passband of the filter stage is located in positive or negative frequencies.

FIGS. 4a and 4b present a differential mode implementation of the transconductance amplifiers 26-29. The well-known basic differential pair is drawn in FIG. 4a and this differential pair can be used as the first 26 and the fourth transconductance amplifier 29. Transistors Q1 and Q2 are the actual active elements in the circuit. In this case the transconductance gm1 of the transconductance amplifier of FIG. 4a is set by the resistors Re1, Re2 and the current source lee1. FIG. 4b presents an example of a transconductance amplifier which has a control input for selecting the sign of the transconductance. The sign selection is implemented as an analog multiplier structure. The structure has two switches S1, S2 and an inverter INV. The first switch S1 is controlled by the filter control signal 3 and the second switch S2 is controlled by the signal inverted by the inverter INV, i.e. the inverted filter control signal 3. When the filter control signal 3 has a value which switches the first switch S1 on, the second switch S2 is switched off. This structure can be used as the second 27 and the third transconductance amplifier 28 of the filter 14. Transistors Q3p, Q4p and Q3n, Q4n form differential pairs that are enabled or disabled by directing the current lee2 through them by switches S1 and S2. Only one pair at a time is biased i.e. the inverter block INV inverts the value of the select signal wherein only the first switch S1 or the second switch S2 is conducting at any given time, depending on the value of the select signal. The transistors Q3p and Q4p with their degeneration resistors form the gm2 cell for positive frequencies and Q3n and Q4n with their degeneration resistors form the gm2 cell for negative frequencies. The transconductance gm2 of the transconductance amplifier of FIG. 4b is defined by the resistors Re3p, Re4p, Re3n, Re4n and the current source lee2.

The filter stage formed by transconductance amplifiers of FIGS. 4a and 4b that are connected as shown in FIG. 3 has the following bandpass function for each of the complex signal branches when the passband is set to positive frequencies:

$${H}_{bp} ( s ) = \frac{K}{1 - j \cdot {g}_{m2} R + \frac{s}{{ω}_{p}}} \qquad ( 5 )$$

In the equation (5) H_{bp}(s) means the bandpass transfer function of the filter stage. K is a voltage gain coefficient defined by 26, 30, 29 and 32 of FIG. 3 and ωₚ is the low-pass equivalent bandwidth set by 30, 31, 32 and 33 of FIG. 3.

Any lowpass function can be transformed into a complex bandpass function by cascading blocks having transfer function like that described above.

The passband defined by the pole can be switched to negative frequencies by changing the polarity of the outputs of the second 27 and the third transconductance amplifier 28.

In more detail, the voltage transfer function of the filter stage of FIG. 3 can be expressed as:

$$[ \begin{matrix}{V}_{out , I} ( s ) \\ {V}_{out , Q} ( s )\end{matrix} ] = [ \begin{matrix}{H}_{I} ( s ) & ( 2 α - 1 ) \cdot {H}_{Q} ( s ) \\ ( 1 - 2 α ) \cdot {H}_{Q} ( s ) & {H}_{I} ( s )\end{matrix} ] [ \begin{matrix}{V}_{in , I} ( s ) \\ {V}_{in , Q} ( s )\end{matrix} ] , \\ where$$

$$\{ \begin{matrix}\begin{matrix}{H}_{I} ( s ) = \frac{{g}_{m1} \cdot {Z}_{L} ( s )}{1 + {g}_{m2}^{2} \cdot {{Z}_{L} ( s )}^{2}} \\ {H}_{Q} ( s ) = \frac{{g}_{m1} \cdot {g}_{m2} \cdot {Z}_{L} ( s )}{1 + {g}_{m2}^{2} \cdot {{Z}_{L} ( s )}^{2}}\end{matrix} \\ αε [ 0 , 1 ]\end{matrix}$$

Vin,I(s) is the voltage at the in-phase input 21 of the filter 14 and Vin,Q(s) is the voltage at the quadrature-phase input 22 of the filter 14. Vout,I(s) is the voltage at the in-phase output 23 of the filter 14 and Vout,Q(s) is the voltage at the quadrature-phase output 24 of the filter 14. ZL(s) is the load impedance defined by the resistors 30 and 32 and capacitors 31 and 33. The binary variable a presents the filter control signal at the control input 34. By cascading these kind of filter stages any band pass function, e.g. butterworth or chebyshev type, for a complex signal can be realized with the possibility to select positive or negative IF.

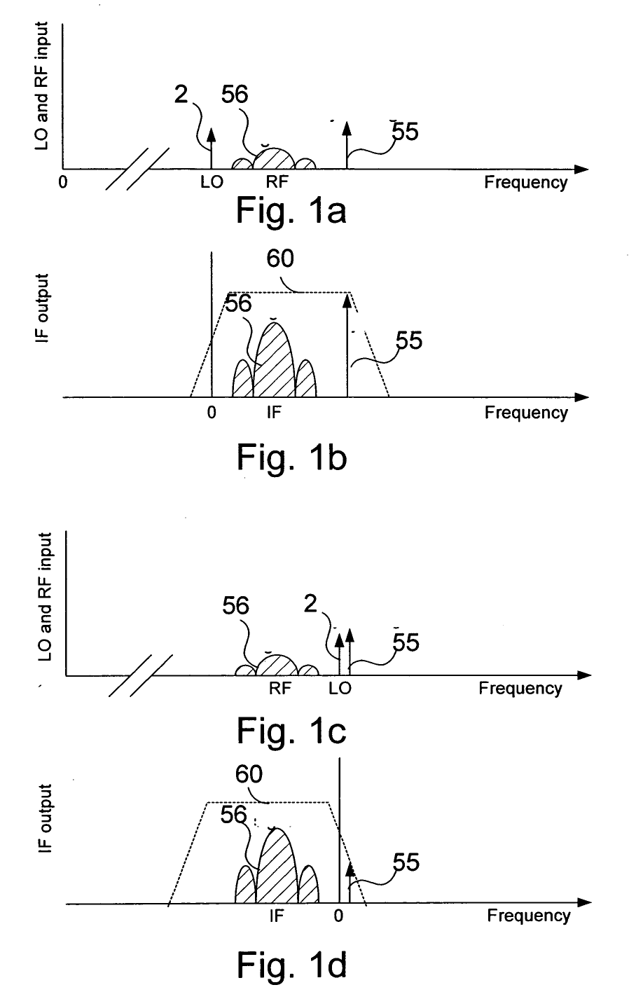

When the receiver 51 is used in a multistandard system jamming signals may exist in the input of the receiver that is outside the actual signal band but still in the received analog band. In a case like that it is useful to have an option of changing the complex IF from positive to negative frequencies or vice versa. The changing can be performed e.g. as follows. It is assumed that there exists a jamming signal which is near and higher than the frequency of the local oscillator signal and, hence, is downconverted to the IF band. If the complex IF is operating on positive frequencies it should therefore be changed to operate on negative frequencies. To achieve this, the frequency of the local oscillator signal 2 is changed to a value which is above the wanted channel and the filter control signal 3 is set to a value which selects the sign of the transconductance gm2 of the second transconductance amplifier 27 negative and the sign of the transconductance gm3 of the third transconductance amplifier to a positive value. Respectively, if the complex IF is operating on negative frequencies it should be changed to operate on positive frequencies. To achieve this, the frequency of the local oscillator signal 2 is changed to a value which is below the wanted channel and the filter control signal 3 is set to a value which selects the sign of the transconductance gm2 of the second transconductance amplifier 27 positive and the sign of the transconductance gm3 of the third transconductance amplifier to a negative value. The downconverted jamming signal can be moved out of the complex IF filter passband and so it becomes attenuated. The attached FIGS. 1a to 1d show in the frequency domain how it happens. In FIGS. 1a and 1c the spectrum of the local oscillator signal 2 in the mixer input, the wanted signal 56 and the narrowband jamming signal 55 in the RF input 1 of the receiver 51 are depicted. The difference between FIGS. 1a and 1c is that in FIG. 1a the frequency of the local oscillator signal 2 (LO) is below the wanted channel (RF), i.e. the frequency of the local oscillator signal 2 is lower than frequencies of the wanted signals, and in FIG. 1c the frequency of the local oscillator signal 2 (LO) is above the wanted channel (RF), i.e. the frequency of the local oscillator signal 2 is higher than frequencies of the wanted signals. If the local oscillator signal 2 is set to the frequency determined by RF-IF as can be deduced on the basis of FIGS. 1a and 1b (LO is below RF and IF is above 0 Hz), and the passband 60 of the IF filter 14 is set to positive frequencies it results a signal spectrum at the IF output 6, 7 of the receiver 51 as depicted in FIG. 1b in which the dotted line describes the response of the filter 14. The jamming signal 55 gets amplified as much as the wanted signal 56. However, if the frequency of the local oscillator signal 2 is set to RF+IF (FIG. 1c) and the IF filter is set to negative frequencies the situation changes like shown in FIG. 1d. Now the jamming signal 55 gets converted out of the complex IF filter 14 passband and so becomes attenuated compared to the wanted signal 56.

The electronic device 50 may also comprise a transmitter 58 and another receiver 57. The transmitter 58 and the another receiver 57 may be, for example, a transmitter-receiver pair for mobile communication, such as a GSM transmitter-receiver pair. The electronic device of FIG. 5 also comprises the controller and application processor 54 for controlling the operation of the electronic device, the transmitter 58, the receivers 51, 57, etc. For example, the controller and application processor 54 instructs the transmitter 58 to transmit signals when necessary. If the transmitter 58 transmits at a frequency channel which may affect that jamming signals are generated at the input 1 of the receiver 51 the controller and application processor 54 informs the block 17 of that. The block 17 then controls the frequency synthesizer 19 to change the frequency of the local oscillator signal 2 and also controls the filter 14 by the filter control signal 3 to change the passband of the filter 14 either to positive or negative frequencies when necessary.

The electronic device 50 may also comprise means for determining whether external jamming signals exist at the input 1 of the receiver 51. Such means can comprise, for example, a tunable passband filter (not shown) and a signal strength measuring means (not shown). The signal strength measuring means measure the signal strength at the output of the tunable passband filter. When the passband of the tunable passband filter is near the frequency of the local oscillator signal 2, the signal strength measuring device indicates if there exists a signal on the passband of the tunable passband filter. The local oscillator may be switched off when the measurement is performed to avoid that the local oscillator signal could be determined as a jamming signal. Another option is that the DSP/control unit 17 of the receiver 51 uses output data of the analog-to-digital converters 15 and 16 to detect the possible jammer. The result of the determination can then be used to decide the necessary changes, if any, to the passband of the filter 14 and to the frequency of the local oscillator signal 2. In the determination the location of the jamming signal with respect to the wanted signal can be used as the basis for selecting the passband to be either negative or positive and whether the frequency of the local oscillator signal is to be set lower or higher than frequencies of the wanted signals. For example in the situation of FIG. 1c the frequency of the local oscillator signal is higher than frequencies of the wanted signals, near the frequency of the jamming signal. Furthermore, the passband of the filter 14 is (mainly) in negative frequencies. If the jamming signal existed below the wanted signal, the situation would be reversed.

The electronic device 50 may further comprise a user interface 61 comprising a keypad 61.1, a display 61.2 and/or audio means including a codec 61.3, a microphone 61.4, and a speaker 61.5, for example. The electronic device also comprises memory 62. The electronic device 50 is, for example, a single-mode or a multi-mode mobile communication device with or without a satellite positioning receiver, etc.

The present invention is not restricted solely to the embodiments presented above, but it can be varied within the scope of the appended claims.

1. Intermediate frequency (IF) polyphase filter for filtering received radio frequency (RF) signals downconverted into intermediate frequency signals, comprising a definer for defining a passband for the IF polyphase filter, and a passband adapting element for setting the passband of the IF polyphase filter in positive or in negative frequencies.

2. The IF polyphase filter according to claim 1, comprising a first transconductance amplifier and a fourth transconductance amplifier for amplifying the intermediate frequency signals, and a second transconductance amplifier and a third transconductance amplifier for setting the passband of the IF polyphase filter in positive or in negative frequencies.

3. The IF polyphase filter according to claim 2, wherein said passband adapting element comprises means for setting transconductance of said second transconductance amplifier and third transconductance amplifier to positive or negative.

4. The IF polyphase filter according to claim 3, wherein each of said second transconductance amplifier and third transconductance amplifier comprises:
a first differential pair and a second differential pair, and
a first switch, a second switch, an inverter (INV) and a select input for activating either said first differential pair or said second differential pair and setting said transconductance to positive or negative for constituting a wanted multiplier function.

5. Receiver comprising at least an input for receiving radio frequency (RF) signals, a downconverter for downconverting received RF signals into intermediate frequency (IF) signals, an IF polyphase filter for filtering the intermediate frequency signals to separate wanted signals from disturbing signals, and a passband adapting element for setting a passband of the IF polyphase filter in positive or in negative frequencies.

6. The receiver according to claim 5, wherein said downconverter comprises a signal generator for generating a local oscillator signal, wherein said passband adapting element further comprises means for setting a frequency of the local oscillator signal either lower than a frequency of the received RF signals or higher than the frequency of the received RF signals, depending on whether the passband of the IF polyphase filter is in positive or in negative frequencies.

7. Receiver of a mobile communication device comprising at least an input for receiving radio frequency (RF) signals, a downconverter for downconverting the received RF signals into intermediate frequency signals, an intermediate frequency (IF) polyphase filter for filtering the intermediate frequency signals to separate wanted signals from disturbing signals, and a passband adapting element for setting a passband of the IF polyphase filter in positive or in negative frequencies.

8. A device comprising a receiver, which comprises at least an input for receiving radio frequency (RF) signals, a downconverter for downconverting received RF signals into intermediate frequency (IF) signals, an IF polyphase filter for filtering the intermediate frequency signals to separate wanted signals from disturbing signals, and a passband adapting element for setting a passband of the IF polyphase filter in positive or in negative frequencies.

9. The device according to claim 8, wherein said downconverter comprises means for generating a local oscillator signal, wherein said passband adapting element further comprise means for setting a frequency of the local oscillator signal either lower than a frequency of the received RF signals or higher than the frequency of the received RF signals, depending on whether the passband of the IF polyphase filter is in positive or in negative frequencies.

10. Mobile communication device comprising a receiver, which comprises at least an input for receiving radio frequency (RF) signals, a downconverter for downconverting received RF signals into intermediate frequency (IF) signals, an IF polyphase filter for filtering the intermediate frequency signals to separate wanted signals from disturbing signals, and a passband adapting element for setting a passband of the IF polyphase filter in positive or in negative frequencies.

11. Satellite positioning receiver, which comprises at least an input for receiving radio frequency (RF) signals, a downconverter for downconverting the received RF signals into intermediate frequency signals, an IF polyphase filter for filtering the intermediate frequency signals to separate wanted signals from disturbing signals, and a passband adapting element for setting a passband of the IF polyphase filter in positive or in negative frequencies.

12. Method for filtering received radio frequency (RF) signals by using an intermediate frequency (IF) polyphase filter, the method comprising downconverting received RF signals into intermediate frequency (IF) signals before filtering them in the IF polyphase filter, and defining a passband for the IF polyphase filter, wherein the passband of the IF polyphase filter is set in positive or in negative frequencies.

13. The method according to claim 12, wherein for said downconverting a local oscillator signal is generated, wherein setting a frequency of the local oscillator signal either lower than a frequency of the received RF signals or higher than the frequency of the received RF signals, and setting the passband of the IF polyphase filter in positive frequencies, if the frequency of the local oscillator signal is below a wanted channel, or in negative frequencies, if the frequency of the local oscillator signal is above the wanted channel.

14. The method according to claim 13, further comprising determining a location of a jamming signal with respect to the wanted signal for selecting the passband to be either negative or positive and whether the frequency of the local oscillator signal is set lower or higher than frequencies of the wanted channel.

15. The method according to claim 14, wherein if it is determined that the frequency of the jamming signal is higher than frequencies of the wanted channel, the frequency of the local oscillator signal is set above the frequencies of the wanted channel, and the passband of the filter is set in negative frequencies.

16. System comprising a receiver, which comprises at least an input for receiving radio frequency (RF) signals, a downconverter for downconverting received RF signals into intermediate frequency (IF) signals, an IF polyphase filter for filtering the intermediate frequency signals to separate wanted signals from disturbing signals, and a passband adapting element for setting a passband of the IF polyphase filter in positive or in negative frequencies.

17. Satellite positioning receiver comprising at least an input for receiving radio frequency (RF) signals, a downconverter for downconverting received RF signals into intermediate frequency (IF) signals, an IF polyphase filter for filtering the intermediate frequency signals to separate wanted signals from disturbing signals, and a passband adapting element for setting a passband of the IF polyphase filter in positive or in negative frequencies.
